(19) United States
(12) Patent Application Publication
(10) Pub. No.: US 2005/0212270 A1
(43) Pub. Date: Sep. 29, 2005

(54) Unfolding assist mechanism for side curtain air bag

(75) Inventors: Pongdet P. Wipasuramonton, Rochester, MI (US); Chang-Hwan Ju, Rochester, MI (US); Kenneth D. Moniaci, Royal Oak, MI (US); Sherri Chandra, Farmington Hills, MI (US); Jeffery S. Coon, Sterling Heights, MI (US); Seung Ho Choi, Lake Orion, MI (US); Bruce A. Kalandek, Dearborn, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: Key Safety Systems, Inc.

(21) Appl. No.: 11/066,350

(22) Filed: Feb. 25, 2005

Related U.S. Application Data
(60) Provisional application No. 60/556,907, filed on Mar. 26, 2004.

(51) Int. Cl. B60R 21/22

(52) U.S. Cl. 280/730.2

(57) ABSTRACT

A side curtain air bag provides a region to assist a slower region to unfold at a faster rate during air bag deployment. A first region is relatively uninflatable compared to a second inflatable region. The inflatable second region is generally located between the first region and an upper end portion of the air bag. The first region includes two end points and the inflatable second region provides a way for increasing the deployment rate of the first region by extending between the two end points. The inflatable second region height is at least 40% of a height of the air bag to ensure adequate assistance to the first region in unfolding. A gas distribution hose and vent allow inflation gas to flow through and into the inflatable second region to increase the deployment rate of the second region.

### BACKGROUND OF THE INVENTION

This application claims the benefit of U.S. Provisional Application 60/556,907, filed on Mar. 26, 2004. The disclosure of the above application is incorporated herein by reference.

This invention relates to a safety device and, more particularly, to a side curtain air bag cushion and module for protecting a vehicle occupant during a collision.

To reduce the probability of injuries to a vehicle occupant, various safety devices have been introduced. These devices include most notably safety belts and air bag systems to reduce risk of injury in frontal impact, side impact, or vehicle rollover for example. Among the air bag systems are side curtain air bag systems, which generally deploy from an area at or near the roof rail of the vehicle.

Conventional side curtain air bag systems include a sensor, which detects a crash or rollover and activates an inflator. Once activated, the inflator rapidly provides gas that passes through a conduit to the side curtain air bag. The gas fills and inflates the side curtain air bag. The air bag unfolds and extends downward from its stored position to a protective position between the vehicle occupant and the vehicle pillars, side windows, and/or doorframe for example.

Conventional side curtain air bags are made of woven fabric and typically include an inner panel and outer panel made from two separate pieces of fabric secured together or from one piece of fabric configured to form an inflatable chamber. The inner and outer pieces may also be secured together to form inflatable chambers, uninflatable chambers or relatively uninflatable sections. The chambers that do not fully inflate reduce the volume of the inflatable chamber and generally reduce the time required to deploy and inflate the side curtain air bag. In addition, the reduced inflatable volume of the air bag allows utilization of a smaller output inflator, smaller inflator packaging, and results in a generally lighter and less expensive air bag module. The uninflatable sections of the air bag are typically positioned in areas where the occupant does not make contact with the uninflated section during a crash or rollover. The uninflatable sections, however, may have difficulty unfolding because they are not forced downward by inflator gas like the inflatable chambers. With little or no gas pressure, an uninflated section may become caught on the interior vehicle trim, unfold unevenly, or unfold slower, and must be dragged by laterally located inflating regions to unfold.

U.S. Pat. No. 6,457,740 discloses a side curtain air bag that includes an inner and outer panel of fabric sewn together generally about the periphery to form the air bag. Parallel sew lines within the area of the air bag form inflator channels. The air bag further includes a non-inflatable section extending laterally between inflatable sections. An inflatable pillar segment extends partially into the middle of the non-inflatable section to ensure proper inflation of the two inflatable sections and to protect the vehicle occupant from contact with the B-pillar located between the front and rear windows. The inflatable pillar segment does not assist the non-inflatable section in unfolding. Despite this conventional design, a demand remains for air bag designs allowing more uniform deployment of air bags.

Accordingly, it is desirable to provide a side curtain air bag having a region that assists a more slowly unfolding region of the air bag to unfold during air bag deployment.

### SUMMARY OF THE INVENTION

The side curtain air bag of the present invention includes a first region spaced from an upper end portion. The first region is relatively uninflatable; that is, the first region inflates at a rate slower than a second inflatable region or does not inflate at all. The first region includes two end points and an inflatable second region and provides a means for increasing the deployment rate of the first region by extending between the two end points. In one example, the second region is sharply concave (including being triangular) and includes widths that change from a base portion to a peak portion.

In another example, an inflatable second region is located between a first region and an upper end portion of the air bag and provides a means for increasing the deployment rate of the first region. A non-linear boundary is between the first region and the inflatable second region.

In one example, the first region is enclosed within a perimeter of an inflatable region so that the first region is completely surrounded by inflatable portions of the air bag.

In another example, the inflatable second region includes a height that extends from the upper end portion to a peak. The inflatable second region height is at least 40% of a height of the air bag to ensure adequate assistance to the first region in unfolding.

In another example, the inflation gas flows through a gas distribution hose and vent to allow inflation gas to flow through and into the inflatable second region and thereby increase the deployment rate of the first region.

In another example, a seam forms an N-shaped boundary in the first region by securing a front portion to a back portion of the air bag. The N-shaped boundary is located upstream from the first region relative to a gas inlet and inflator.

The side curtain air bag according to the present invention provides a region to assist a slower region to unfold at a faster rate during air bag deployment.

### BRIEF DESCRIPTION OF THE DRAWING

The various features and advantages of this invention will become apparent to those skilled in the art from the following detailed description of the currently preferred embodiment. The drawings that accompany the detailed description can be briefly described as follows.

FIG. 1 shows a side curtain air bag in an inflated and deployed condition;

FIG. 2 shows another side curtain air bag in an inflated and deployed condition; and

FIG. 3 shows another side curtain air bag including an N-shaped configuration.

FIG. 4 shows another embodiment of the invention.

FIG. 5 shows a further embodiment of the invention.

### DETAILED DESCRIPTION OF THE PREFERRED EMBODIMENT

FIG. 1 diagrammatically shows a vehicle 10 having an interior (passenger compartment) 12 with front and rear seats 14 for vehicle occupants. The vehicle 10 includes side windows 15, two or more doors 16 having a doorframe 18 and a vehicle A, B and C (or D) pillars 19, 20 and 21 respectively. An air bag 24 is typically stored along the roof rail 22 of the vehicle located just above the door opening(s). The folded air bag is covered by one or more interior trim pieces, which are dislodged as the air bag inflates. The air bag 24 is depicted in its inflated, or deployed, condition it assumes to protect vehicle occupants in a crash. The air bag can optionally be stored within the doorframe 18.

The air bag 24 includes an inner portion or panel 28a and outer portion or panel 28b. In one example, the inner portion 28a and outer portion 28b are made of fabric and secured together at a perimeter 26 by a sewn seam, interweaving, or other means of securing. The inner portion 28a and outer portion 28b form an inflatable chamber including inflatable regions or chambers 30 (also referred to as a fore and aft inflatable chamber 30a and 30b respectively). An upper end or top portion 32 of the air bag 24 includes attachment portions 36 for securing the air bag 24 to the doorframe 18 or roof rail 22 and a gas inlet 38, which allows inflation gas to enter the air bag 24 from an inflator 59. The front of the air bag (the forward inflatable portion 30a) can be connected directly to the A-pillar or loosely configured. As illustrated the front 23 of the forward inflatable portion 30a is tethered and connected to the A-pillar 19 via a piece of fabric 25 sewn to the air bag. As illustrated this fabric is triangular in shape but can take many forms. The fabric, as shown, is not inflatable but can be configured as an inflatable chamber, such as an extension of chamber 30a. In some known installations, the tether is achieved using a piece of seat belt. The rear 26 of the air bag 24, when inflated, can be loosely positioned relative to the C (or D) pillar 21 as illustrated or tethered thereto.

The air bag further includes a first region 40 located between the fore and aft inflatable regions 30a and 30b and spaced from the upper end or top portion 32. Situated above the first region 40 is another inflatable region or chamber 50 in fluid communication with the chambers 30a and 30b. Region 50 can be considered as an extension of one or both chambers 30a and/or 30b. The first region 40 is configured to inflate at a rate less than an inflatable second region 50, or configured as an uninflatable region. Region 40 is generally located next to a middle pillar such as the vehicle B-pillar 20 of a modest sized vehicle or next to the B or C-pillars of a longer vehicle. In one example, the first region 40 is completely surrounded by inflatable portions of the air bag 24, including inflatable fore and aft regions 30, the inflatable second region 50 and the narrow passages 57 (mentioned below).

The first region 40 is formed in the air bag by a strongly concavely shaped border or boundary 44. In the embodiment of FIG. 1 this border 44 is M-shaped or triangular in shape. In one embodiment the border 44 is achieved by a seam 42, connecting the inner and outer panels, which follows the outer contour of the border 44 of the air bag. In another example, the border 44 is achieved by interweaving the threads, shown by numeral 45, used to form the woven panels 28a and 28b of the air bag 24. The seam 42 or interweaving 45 allows little or no gas to pass through the boundary 44 and forces gas exiting the gas inlet 38 to flow in a tortuous path around, including the top, sides and bottom of the M-shaped border 44. The air bag further includes a plurality of other joined-together regions 47 formed by sewn seams or interweaving, the purpose of which is to reduce the inflatable volume of the air bag. The lower extremes of the border 44 are spaced from the bottom 33 of the air bag to form narrow passages or orifices 57 that impede the flow of inflation gas into the region 40 at least during the initial period of air bag inflation.

The border 44 includes two extreme or end points or apexes 48a and 48b and a single minimum point or nadir 56. The extreme or end points 48a and 48b are defined by the points on the border 44 that are in closest proximity to the upper end or top portion 32. The inflatable second region 50, in concert with the delayed inflation of the first region 40, provides a means for increasing the deployment rate of that portion of the air bag below the border 44, that is for example, the first region 40.

The distance between the extreme points 48a and 48b defines an upper base portion 52 of the inflatable second region 50 of a first width 54. The base portion leads to a trough portion 56 having a narrowing width 58 that tapers toward the nadir 56. The M or triangular shape also provides the added benefit of relatively smaller inflatable air bag volume compared to other possible shapes such as square or circular.

Utilizing a sharply concave shape is especially advantageous for assisting in unfolding that part of the air bag below the region 50, i.e. the first region 40 compared to the prior art. Before a crash, the air bag 24 is stored in an uninflated condition above the vehicle door. In a crash, the air bag 24 inflates with gas from the inflator 59, filling these inflatable regions (30 and 50) above the border 44, pushing the air bag downward to its deployed state. The fore and aft regions 30a and 30b of the air bag deploy downwardly relatively quickly; however, inflation gas flow from chambers 30a and 30b to region 40 is impeded by the narrow passages or orifices 57. During a typical inflation event, inflation gas is quickly communicated to the upper regions of chambers 30a, 30b and 50. Typically, when using relatively narrow passages 57, even after a few milliseconds from initiation of the inflator to full inflation and deployment of the air bag, region 40 does not fill much. Region 40 acts as an accumulator chamber to receive inflation gas that can be pushed through passages 57 into region 40 upon further pressurization of the bag as it is compressed by a portion of the occupant to be protected The inflation gas within the medial region 50, in concert with the M-shaped border 44, acts as a pneumatic wedge forcing the medial portion of the air bag downwardly against the less inflated or uninflated region 40. As can be appreciated the legs 44a and 44b of the border 44 can extend to the bottom 33 of the air bag; in this case the narrow passages or orifices 57 are eliminated and the region 40 does not received any inflation gas.

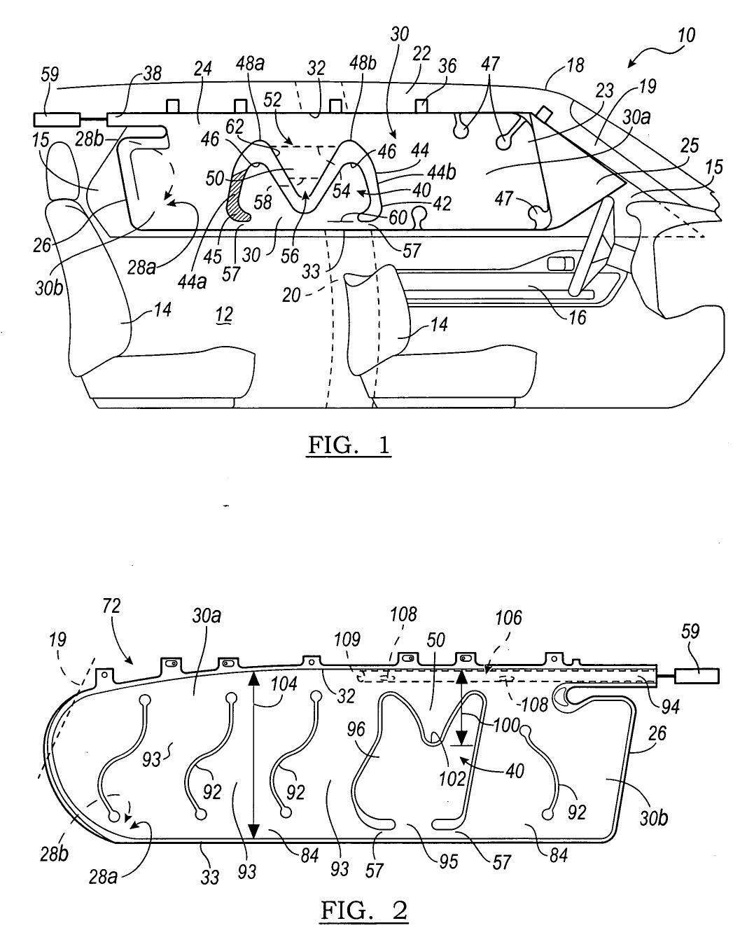

FIG. 2 shows another embodiment of a side curtain air bag 72 having some features similar to that of air bag 24, that is fore and aft inflatable regions 30, a border 44, a first region 40 and region 50.

Air bag 72 further includes a plurality of other joined-together regions or separators 92 formed by sewn seams or interweaving the yarns forming the opposing panels of the air bag. The separators 92 are arcuate in shape and generally extend in a top-to-bottom direction. A purpose of these regions or separators 92 is to reduce the inflatable volume of the air bag. These regions are located in the fore and aft inflatable regions or chambers of the air bag 30 and subdivide chambers 30 into smaller chambers 93.

The operation of this air bag is much the same as air bag 24. The accumulator chamber or region 40 under the M-shaped border 44 is accessible by inflation gas through narrow passages or orifices 57 and the opening 95 receives inflation gas from the inflated chambers 30 during a crash. Initially, as the air bag 72 inflates, the chamber 40 is uninflated. The inflation gas generally takes the path of least resistance in filling and inflating the air bag 72. Thus, the inflation gas must flow around the border 44. In a crash, during the relatively few milliseconds it takes to fill chambers 30, the chamber 40 remains uninflated or relatively uninflated compared to the inflated regions 30. When an occupant contacts the air bag in any of the inflated regions 30 during a crash, some of the gas occupying the chamber 30 is pushed through the passages 57 into opening 95 and into the relatively uninflated accumulator chamber 40, thereby reducing the inflation pressure level in the inflated regions 30 and lessening the rebound force generated by the inflated regions 30.

The nadir 102 of the inflatable second region 50 is spaced from the top of the air bag by a distance 100. Preferably, this distance 100 is a range of at least 40% to 70% or even 100% of a height 104 of the air bag 72 to ensure adequate assistance to the first region 50 in unfolding region 40 of the air bag. At a distance of 100% the nadir is generally at the bottom 33 of the air bag. Distances 100 less than 30% of the height 104 of the air bag can be utilized; however, the increase in the rate of deployment of the first region 50 may be less compared to placing the nadir 96 lower.

The means by which inflation gas is communicated from the inflator to the inflatable regions 30 and 50 will vary with application. In FIG. 1, inflation gas exiting the inlet 38 begins to inflate the closest inflatable chamber first; the other inflatable chambers fill rapidly in quick succession. FIG. 2 illustrates an alternate gas distribution technique in which a gas distribution tube or hose 106 is located within the air bag generally above the inflatable second region 50 along a portion of the top of the bag. In practice, the tube can be a hollow bent or straight metal tube and the hose can be configured as flexible reinforced rubber and/or fabric hose. The gas distribution tube or hose 106 includes one or more vents 108 allowing inflation gas to flow through and directly into the inflatable second region 50, as well as into regions 30a and 30b. The end 109 of the tube or hose 106 can be open or closed depending upon the amount of flow needed to inflate the forward inflatable chamber. By directing inflation gas into the inflatable region 50, the vents 108 provide another means of increasing the deployment rate of the air bag and in particular region 50.

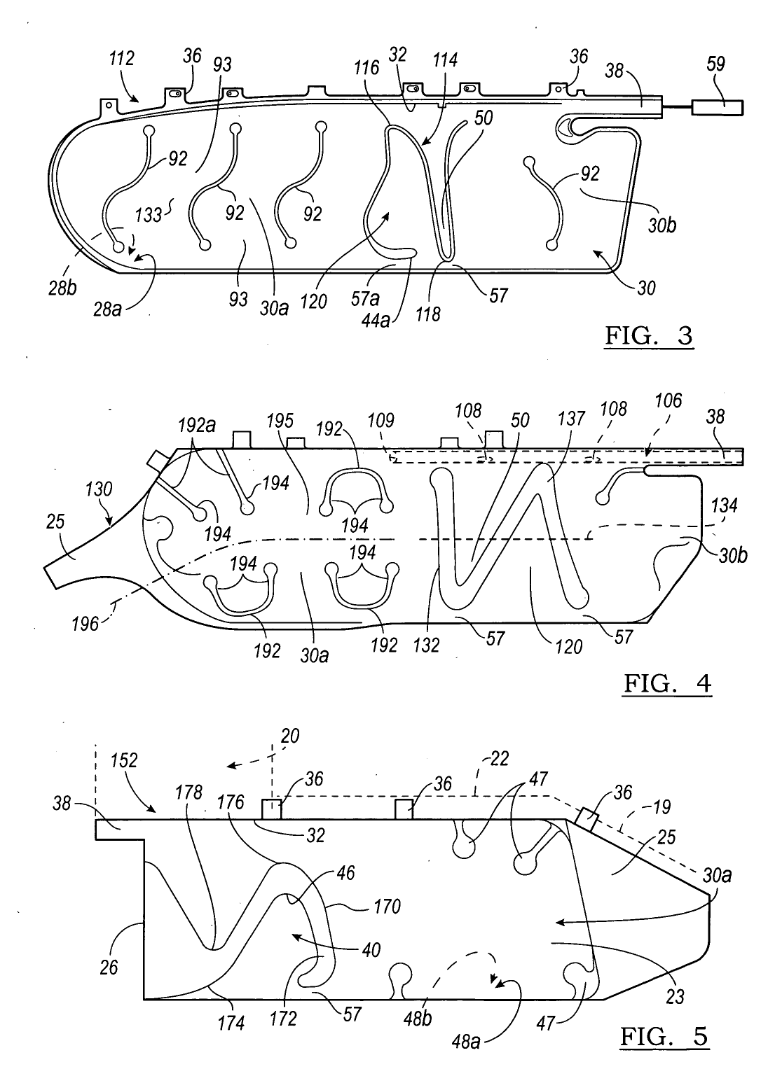

FIG. 3 shows another embodiment of a side curtain air bag 112 having features similar to that of air bags 24 and 72, that is, a fore and aft inflatable region 30a and 30 respectively, a first or medial region 50, attachment portions 36, separators 92 for the fore and aft regions, and an arcuate shaped border or boundary 114 defining the lower extremes of region 50. Border or boundary 114 in this embodiment is N-shaped, and as before, can be formed by sewing or by interweaving the air bag inner and outer panels 28a and 28b together. In the illustrated embodiment the border 114 is asymmetric in shape having a single maximum point 116 (apex, extreme point of inflection) and a single minimum point 118 (nadir, point of inflection).

In the preferred version of this embodiment of the invention the low point or nadir 118 is spaced from the lower side or bottom 33 of the air bag, as is the low point of leg 44a of the region 114. By way of illustration, the nadir is spaced a distance 57 from the bottom while leg 44a is spaced a distance 57a. These distances can be the same or different depending on the desired flow characteristics into and out of the chamber 120. As with region 40, first region 120 is also relatively uninflatable, that is, first region 120 inflates at a rate less than the inflatable second region 50, or is uninflatable.

The N-shaped boundary 114 is also advantageous when the inflatable second region 50 is located upstream of the first region 116 relative to the gas inlet 38 and the inflator 59 and is easily configurable to provide a narrow dimensioned region 120. As gas fills the air bag 112, it is forcibly unfolded by the filling force of the gas. The inflatable second region 50 is inflated and begins unfolding essentially before inflation gas reaches the extreme arcuate portion 116. As the second region 50 unfolds, it forcibly pushes on the non-linear boundary 114, thereby assisting the first region 120 to unfold.

Reference is briefly made to FIG. 4 showing another embodiment of the invention. Air bag 130 includes an N-shaped border 132 that positions region 120 closer to the inlet than region 50. This N-shaped border 132 is generally symmetrically configured about a horizontal axis 134 (shown in phantom line). Air bag 130 includes a distribution tube or hose 106 with vents 108 and end 109 and functions to directly communicate inflation gas from the inlet 38 to the inflatable chambers 30a, 30b and 50. Air bag 130 further includes a plurality of other joined-together regions or separators 192 and 192a, similar in function to separators 92, formed by sewn seams or interweaving the yarns forming the opposing panels of the air bag. By way of illustration, three of the separators 192 are arcuately shaped and do not extend to the extremes of the air bag. Two of the separators 192a are linear in shape and extend from the edge of the air bag. Each of the separators 192, 192a has a commonly shaped terminal portion 194 positioned apart from an axis 196 of chamber 30a. The enlarged lobes of each terminal portion 194 act as a stress reducer lowering stresses forming in the air bag fabric during inflation and impact by an occupant. Each of the separators 192, 192a reduces the inflatable volume of chamber 30a, and the spacing of the respective terminal ends 194 permits a center portion 195 of chamber 30a about axis 196 to inflate to its maximum permitted width without any constrictions in this region, which corresponds to the region where a head of the occupant to be protected is most probable to come in contact with the air bag.

FIG. 5 shows another embodiment of a side curtain air bag 152. The air bag 152 is configured to protect a single vehicle occupant, such as the driver or front seat passenger of a vehicle. This air bag is substantially similar to air bag 24 in construction but is significantly shorter in length as it will extend only from about the A-pillar to about the B-pillar 20 (shown in phantom line) of the vehicle and when inflated will also extend down from the vehicle's roof rail as did the air bag 24. The above described air bags 24, 112, etc., are sufficiently long to extend between the A-pillar to the C or D-pillar of the vehicle. This air bag 152 includes one major inflatable region 30a secured to the A-pillar via a fabric panel 25. The air bag 152 is located proximate the vehicle side window to protect the driver or front passenger as the case may be. As illustrated, the rear 26 of the air bag is loosely configured relative to the B-pillar. The rear 26 of the air bag can also be connected to the B-pillar via a fabric strap or other type of tether. Air bag 152 also includes a boundary 170, separating chamber 50 from chamber 40. The boundary 170 includes a leg 172, a terminal end thereof spaced from the bottom 33 of the air bag by a passage 57. The lower extreme 174 of the boundary, proximate end 26 of the air bag 152, extends to or approximately to the bottom of the air bag. The upper extreme 176 of the boundary is sharply concave in shape and includes a low point 178 sufficiently close to the bottom of the air bag to encourage rapid inflation of this portion of the air bag.

Although a preferred embodiment of this invention has been disclosed, a worker of ordinary skill in this art would recognize that certain modifications would come within the scope of this invention. For that reason, the following claims should be studied to determine the true scope and content of this invention.

1. An air bag adapted to be stored in a location proximate an upper portion of a vehicle and when inflated deploys generally downward from its stored location to an inflated configuration, the air bag comprising:
an upper end portion;
a first region that is spaced from said upper end portion and inflates at a lesser rate than said upper end portion; and
an inflatable second region located between said first region and said upper end portion to assist in unfolding said first region during air bag deployment.

2. The air bag as recited in claim 1, wherein said inflatable second region extends at least about 30% of the height of the air bag.

3. The air bag as recited in claim 1, wherein said first region inflates at a rate less than that of said inflatable second region.

4. The air bag as recited in claim 4, wherein said first region comprises a chamber that receives inflation gas from an inflatable region when said inflatable region is contacted by an occupant.

5. The air bag as recited in claim 1, wherein said first region comprises a portion that is uninflatable.

6. The air bag as recited in claim 1, wherein a non-linear boundary is between said inflatable second region and said first region.

7. The air bag as recited in claim 6, wherein said non-linear boundary is concave.

8. The air bag as recited in claim 1, wherein a gas distribution hose in fluid communication with said air bag comprises a vent located adjacent to said inflatable second region.

9. The air bag as recited in claim 1, wherein said inflatable second region is located upstream from said first region relative to a source of inflation gas.

10. The air bag as recited in claim 1, wherein said first region comprises an M-shaped boundary.

11. The air bag as recited in claim 1, wherein said first region comprises an N-shaped boundary.

12. An air bag adapted to be stored in a location proximate an upper portion of a vehicle and when inflated deploys generally downward from its stored location to an inflated configuration, the air bag comprising:
a first region comprising two end points; and
an inflatable second region extending between said two end points to assist in unfolding said first region during air bag deployment.

13. The air bag as recited in claim 12, wherein said first region comprises a portion that inflates at a rate less than that of said inflatable second region.

14. The air bag as recited in claim 12, wherein said first region comprises a portion that is uninflatable.

15. The air bag as recited in claim 12, wherein said inflatable second region comprises a triangular shape.

16. An air bag adapted to be stored in a location proximate a top of a side window of a vehicle and when inflated deploys generally downward from its stored location to a an inflated configuration, the air bag comprising:
a first region configured to deploy at a first deployment rate;
an inflatable second portion configured to deploy at a second rate that is greater than said first rate; and
a first means associated with the first region for increasing the first deployment rate.

17. The air bag as recited in claim 17, wherein said first means is configured to push into an upper boundary of said first region to unfold said first region.

18. The air bag as recited in claim 17, wherein said first means comprises a vent disposed in a gas distribution hose located adjacent to said inflatable second region.
